(19) United States
(12) Patent Application Publication
(10) Pub. No.: US 2016/0226322 A1
(43) Pub. Date: Aug. 4, 2016

(54) Motor Armature

(71) Applicant: Johnson Electric S.A., Murten (CH)

(72) Inventors: Yue LI, Hong Kong (CN); Mao Xiong JIANG, Shen Zhen (CN); Jian ZHAO, Shen Zhen (CN); Yong WANG, Shen Zhen (CN); Yong LI, Shen Zhen (CN); Yan Fei LIAO, Shen Zhen (CN)

(21) Appl. No.: 15/011,192

(22) Filed: Jan. 29, 2016

(30) Foreign Application Priority Data
Jan. 30, 2015 (CN) 201510050696.3
Jan. 30, 2015 (CN) 201510054879.2

(51) Int. Cl. H02K 1/14; H02K 15/02

(52) U.S. Cl. CPC H02K 1/148; H02K 15/022

(57) ABSTRACT

A motor armature includes a core and windings wound around the core. The core includes an annular yoke and a plurality of teeth extending radially outwardly from the yoke. Each of the teeth includes a winding portion connected with the yoke and a tip formed at a distal end of the winding portion. Each tip has circumferential opposite ends extending beyond the winding portion. A slot opening is forming between ends of adjacent tips. Each of the teeth has a slit on a single circumferential side thereof such that one of the ends of the tip is outwardly tilted relative to the other of end at an original position and is bendable inwardly about the slit to a deformed position where a width of the slot opening is less than that of the slot opening at the original position.

### CROSS REFERENCE TO RELATED APPLICATIONS

This non-provisional patent application claims priority under 35 U.S.C. §119(a) from Patent Application No. 201510050696.3 filed in The People's Republic of China on Jan. 30, 2015, and from Patent Application No. 201510054879.2 filed in The People's Republic of China on Jan. 30, 2015, the entire contents of both are hereby incorporated by reference.

### FIELD OF THE INVENTION

This invention relates to motor armatures and in particular, to a stator for an outer rotor motor.

### BACKGROUND OF THE INVENTION

As is known, a motor includes a rotor and a stator that magnetically interact to drive the rotor to rotate, which rotor in turn drives a load. According to the position relationship between the rotor and stator, motors can be classified into inner rotor motor and outer rotor motor. As the name suggests, the outer rotor motor is one in which the rotor surrounds an inner stator. The load such as a fan can be directly disposed on the rotor. Due to the advantages of large rotational inertia and saving copper wires, the outer rotor motors are widely used in ventilators, instruments, range hoods and the like.

The stator structure of the conventional outer rotor motor usually includes a core and windings wound around the core. The core is formed by stacking a large quantity of silicon steel sheets, referred to as laminations. Each silicon steel sheet includes an annular yoke and teeth extending radially outwardly from the yoke. The windings are wound around the teeth. For facilitating subsequent winding of the windings, adjacent teeth of the core of the convention stator structure have a large gap there between, i.e. having a large width tooth slot, which results in a large cogging torque and hence affects the motor performance. In addition, in forming this core structure, laminations are punched to form the annular yoke and the spaced teeth. The material parts corresponding to the portions between the teeth and inside the yoke are removed as waste material, which, to a large extent, causes the waste of material.

### SUMMARY OF THE INVENTION

Hence there is a desire for a motor armature which has a reduced cogging torque and increased material utilization rate.

Accordingly, in one aspect thereof, the present invention provides a motor armature comprising: a core, comprising an annular yoke and a plurality of teeth extending radially outwardly from an outer edge of the yoke, each of the teeth comprising a winding portion connected with the yoke and a tip formed at a distal end of the winding portion, each tip having circumferential opposite ends extending beyond the winding portion, a slot opening being formed between ends of adjacent tips; and windings wound around the winding portions of the teeth of the core and disposed inside the tips, wherein a slit is formed in each of the teeth on a single circumferential side thereof such that one of said opposite ends of the tip is outwardly tilted relative to the other of said opposite ends in an original position and is bendable inwardly about the slit to a deformed position where a width of the slot opening is less than the width of the slot opening in the original position.

Preferably, the slit is formed in an area where the tip and the winding portion are connected.

Preferably, the slit extends into the tooth in a circumferential direction of the core and has a depth less than a half of the circumferential width of the winding portion.

Alternatively, the slit is formed in the part of the tip that extends beyond the winding portion, and the slit extends outwardly a distance into the tip from an inner surface of the tip.

Alternatively, the slit is formed in the winding portion.

Preferably, the slit extends into the tooth from an area where the tip and the winding portion are connected and then bends to extend a distance toward an outer surface of the tip.

Preferably, when the core is unfold in a circumferential direction, a sum of the widths of the parts of the tip extending beyond the winding portion is greater than a distance between adjacent winding portions.

Preferably, the core is formed by spirally winding a strip material.

Alternatively, the core is formed by a stack of laminations, and each lamination is bent, with opposite ends of the lamination connected to each other.

Alternatively, the core is formed by a stack of punched laminations.

Preferably, parts of each of the teeth on opposite sides of the slit form a latching structure.

Preferably, the latching structure comprises a latching protrusion formed on one of the tip and winding portion and a latching opening formed in the other of the tip and winding portion.

Preferably, the core is fastened together by four weld joints which are located at four ends of an English alphabet X.

Preferably, the core is formed by spirally winding a strip material with a starting tooth and an ending tooth, one weld joint is located at an outer circumferential surface of the tip of the starting tooth of the strip material, another weld joint is located at an outer circumferential surface of the tip of the end tooth of the strip material, and the other two weld joints are respectively located at outer circumferential surfaces of the tips of teeth diametrically opposing the starting and end teeth.

Alternatively, the core is formed by a stack of laminations each of which is bent from a strip material with a starting tooth and an ending tooth, one weld joint is located at an outer circumferential surface of the tip of the starting tooth of the strip material, another weld joint is located at an outer circumferential surface of the tip of the end tooth of the strip material, and the other two weld joints are respectively located at outer circumferential surfaces of the tips of teeth diametrically opposing the starting and end teeth.

According to a second aspect, the present invention provides a method of making a motor armature, the method comprising: providing a strip material which comprises an elongated yoke blank and a plurality of tooth blanks extending from the yoke blank, each tooth blank comprising a linear portion connected to the yoke blank and a tip formed at a distal end of the linear portion, opposite sides of the tip extending beyond the linear portion, a notch being formed in each tooth blank on a single side thereof such that one of said opposite ends of the tip is outwardly tilted relative to the other of said opposite ends; forming a core by spirally winding the strip or by stacking laminations formed by bending the strip, whereby the yoke blank forms an annular yoke, the tooth blanks being stacked to form teeth extending outwardly from the yoke, and the notches form slits in the teeth; and winding windings around the teeth.

Preferably, the method further comprises sequentially pressing said one of the opposite ends of the tip outwardly tilted in a clockwise direction or anti-clockwise direction to deform the tilted end of the tip to a deformed position close the slits and narrow a gap between adjacent ends of the tips, after the winding step.

Preferably, forming a core further comprises inwardly pressing said one of the opposite ends of the tip outwardly tilted when spirally winding the strip material.

In comparison with the conventional motor armature, the tips of the core of the motor armature of the present invention are tilted outward prior to the forming of the core. Therefore, the tips can have a greater width, while ensuring that adjacent tips have the sufficient distance there between for winding of the windings. After the core is formed, the tips of the adjacent teeth form a narrow slot opening which reduces the cogging torque of the motor.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 illustrates a stator of an outer rotor motor according to one embodiment of the present invention.

FIG. 2 is a plan view of FIG. 1.

FIG. 3 illustrates a core of the stator of FIG. 1, the core being a spiral winding structure.

FIG. 4 is a plan view of FIG. 3.

FIG. 5 illustrates a strip material for forming the core.

FIG. 6 is an enlarged view of a part of the strip material.

FIG. 7 illustrates the punching step for forming the strip material of FIG. 5.

FIG. 8 to FIG. 12 illustrate the strip material according to other embodiments.

FIG. 13 illustrates a core blank formed by spirally winding the strip material.

FIG. 14 is a plan view of FIG. 13.

FIG. 15 illustrates the core blank with the windings wound thereon.

FIG. 16 illustrates a stator according to a second embodiment of the present invention.

FIG. 17 illustrates the core of the stator of FIG. 16, the core being a stack of bent strip materials.

FIG. 18 illustrates a lamination blank of the core of FIG. 17.

FIG. 19 illustrates the lamination after the tips have been pressed.

FIG. 20 illustrates the core blank formed by stacking the lamination blanks.

FIG. 21 illustrates the core blank of FIG. 20, with the winding wound thereon.

FIG. 22 illustrates a stator according to a third embodiment of the present invention, the core being a stacking structure.

FIG. 23 illustrates a punched sheet lamination blank.

FIG. 24 illustrates the core blank formed by the punched sheets of FIG. 23.

FIG. 25 illustrates the core blank of FIG. 24, with the windings wound thereon.

FIG. 26 is an enlarged view of a part of a strip material for forming a stator core according to a fourth embodiment of the present invention.

FIG. 27 illustrates a stator core formed using the strip material of FIG. 26.

### DETAILED DESCRIPTION OF THE PREFERRED EMBODIMENTS

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

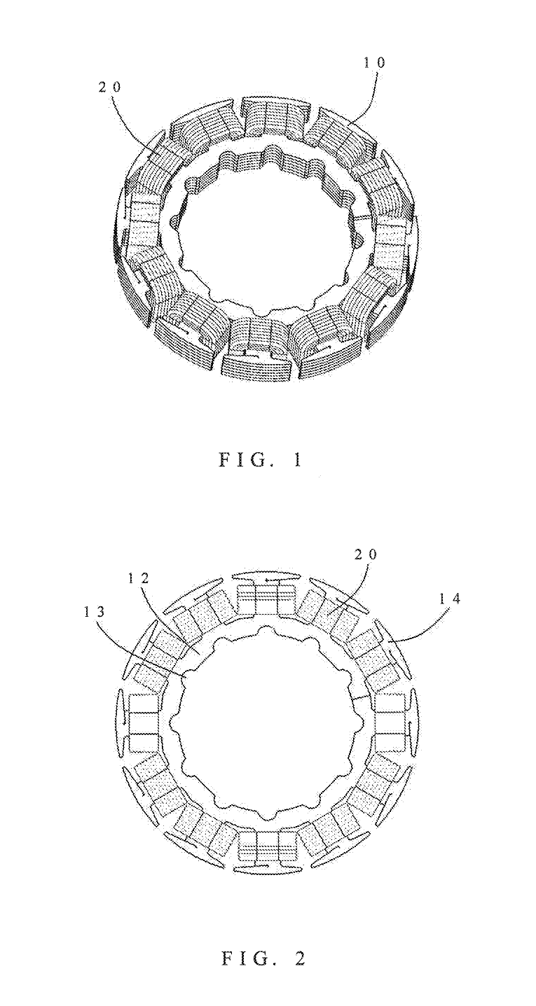

Referring to FIG. 1 and FIG. 2, the stator of the outer rotor motor according to one embodiment of the present invention includes a core 10 made of magnetically conductive material such as iron and windings 20 wound around the core 10. The core 10 includes an annular yoke 12 and a plurality of teeth 14 extending radially outwardly from an outer edge of the yoke 12. The windings 20 are wound around the teeth 14 of the core 10. When appropriately energized, the windings 20 produce alternating magnetic flux which interacts with the rotor so as to drive a load.

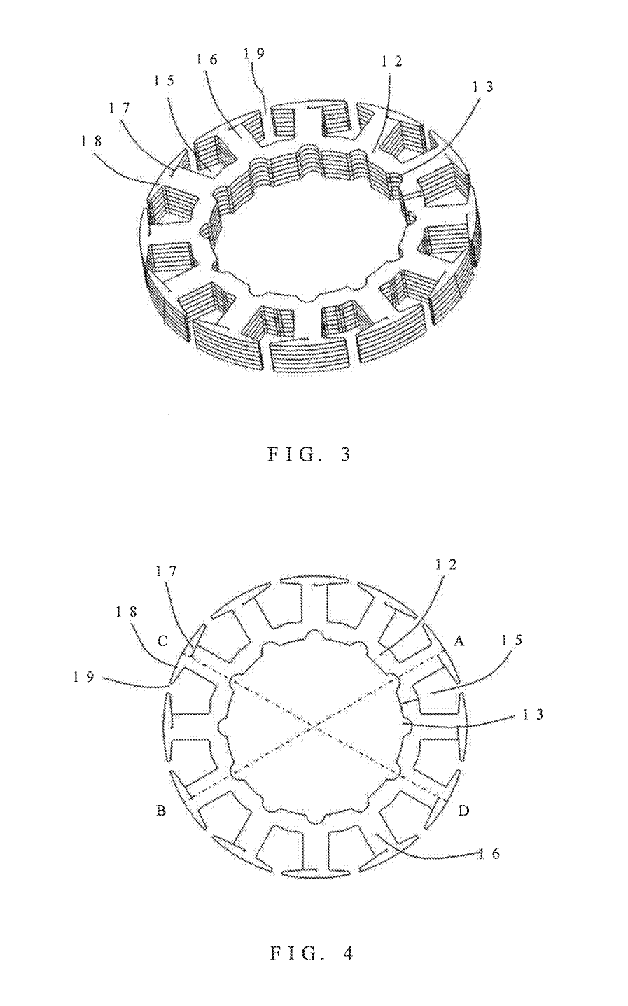

Referring also to FIGS. 3 to 5, in this embodiment, the core 10 includes a plurality of stacked layers made by spirally winding a single piece of strip material 30 to form a unitary structure stator core. The yoke 12 of the core 10 is a hollow cylindrical structure formed by the spiral winding of the strip material 30. A plurality of grooves 13 is formed in an inner surface of the yoke 12, which facilitates bending deformation of the strip material 30 during the spiral winding. The grooves 13 extend in an axial direction of the yoke 12 and preferably have a half-round cross-section. Each groove 13 is radially aligned with a corresponding one of the teeth 14. The teeth 14 are evenly distributed in a circumferential direction of the yoke 12. Each tooth 14 includes a winding portion 16 connected with the yoke 12 and a tip 18 formed at a distal end of the winding portion 16. A winding slot 15 is formed between adjacent winding portions 16. The windings 20 are wound around the winding portions 16 and disposed inside the tips 18. A circumferential width of the tip 18 is greater than that of the winding portion 16. Opposite sides of the tip 18 in the circumferential direction extend beyond the winding portion 16, with a narrow slot opening 19 formed between adjacent tips 18. In this embodiment, a linear slit 17 is formed in an area where the tip 18 and the winding portion 16 are connected. The slit 17 extends in the width direction of the winding portion 16 and has a depth that is approximately a half of the width of the winding portion 16. A left half part of the tip 18 is integrally connected with the winding portion 16, and a right half part of the tip 18 is separated from the winding portion 16 by the slit 17.

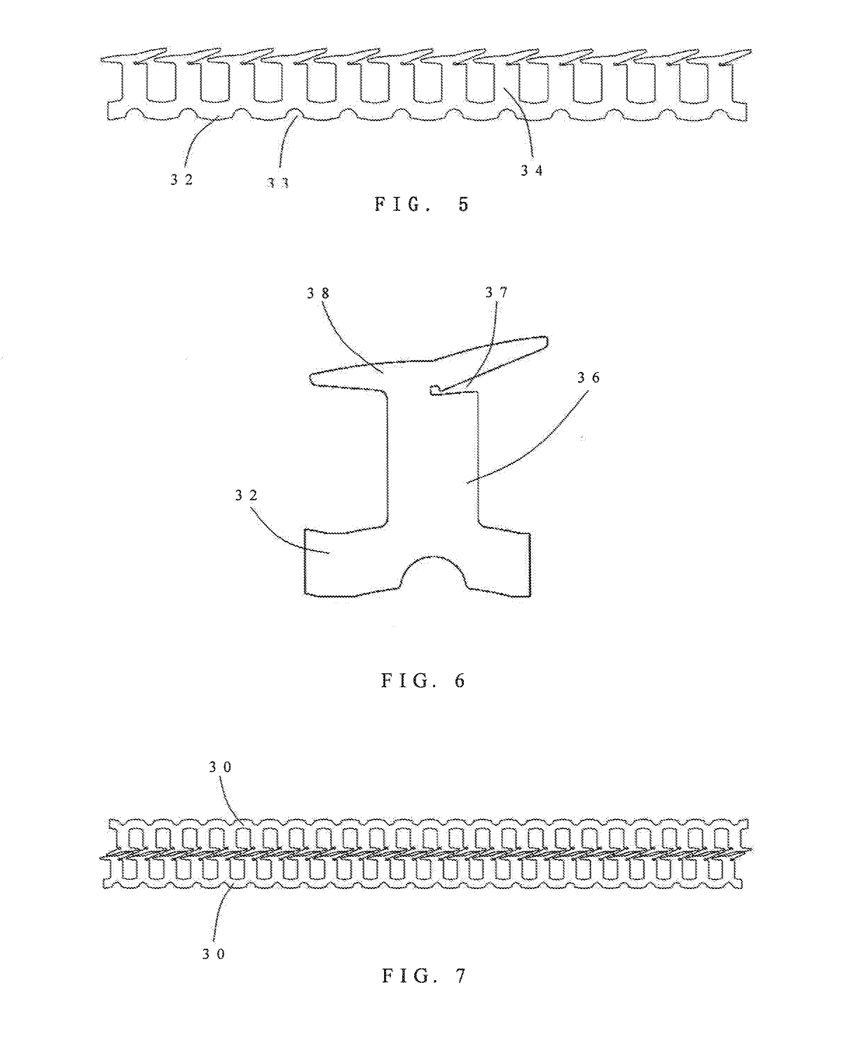

Referring also to FIG. 5 and FIG. 6, the strip material 30 for forming the core 10 has a generally elongated form and includes an elongated yoke blank 32 and a plurality of tooth blanks 34 formed on one side of the yoke 32. A cutout 33 is formed in the other side of the yoke 32, corresponding to each of the teeth 34. In a length direction of the strip material 30, the tooth blanks 34 are spaced apart and arranged parallel to each other. Each tooth blank 34 includes a linear portion 36 and a tip 38 formed at a distal end of the linear portion 36. The tip 38 is greater than the linear portion 36 in width. Opposite sides of the tip 38 extend beyond the linear portion 36. A left half part of the tip 38 is integrally connected with and generally perpendicular to the linear portion 38. A right half part of the tip 38 is tilted outward relative to the left half part, with an angle of greater than 90° formed between the right half part and the linear portion 36. In this embodiment, a sum of the widths of the opposite sides of the tip 38 extending beyond the linear portion 36 is greater than a distance between adjacent linear portions. Because the right half part is tilted outward, adjacent tips 38 overlap with each other in a direction perpendicular to the length direction of the strip material 30. A notch 37 is formed in an area where the right half part of the tip 38 and the linear portion 36 are connected. The notch 37 extends in a width direction of the linear portion 36 and has a depth that is approximately half of the width of the linear portion 36. As such, the right half part of the tip 38 is capable of plastic deformation under an external force and bends toward the linear portion 36 to form a symmetrical structure with the left half part. Alternatively, the depth of the notch 37 is ⅓ of the width of the linear portion 36, which facilitates the deformation of the tip 38 while not having a large influence on the magnetic path.

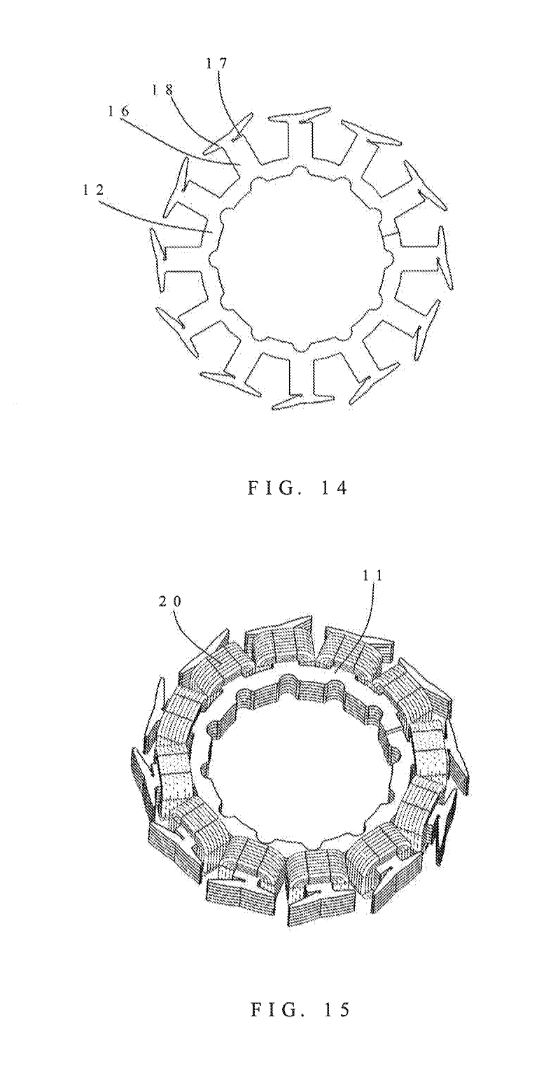

Referring to FIG. 13 and FIG. 14, the strip material 30 is spirally wound to form a core blank 11. The yoke 32 experiences plastic deformation to bend spirally to form the yoke 12 of the core 10. After the yoke 12 is formed, the cutouts 33 are aligned in the axial direction and collectively form the groove 13. Due to the bending of the yoke 32, the teeth 34 that were previously parallel to each other now extend radially outward. The linear portions of the tooth blanks 34 are stacked to collectively form the winding portions 16, and the tips 38 are stacked to collectively form the tips 18. The left half parts of the tips 18 are integrally connected with the winding portions 16, and the right half parts are tilted outward. The notches 37 of the tips 38 are aligned to form the slits 17 of the teeth 14. The slits 17 separate the right half parts of the tips 18 apart from the winding portions 16, such that the right half parts of the tips 18 are capable of bending relative to the winding portions 16. Because the teeth 34 extend radially outward, the distance between adjacent winding portions 16 increases gradually in the radially outward direction. The maximum distance, i.e. at the area where the winding portion 16 and the tip 18 are connected, is greater than the widths of the part of the tips 18 extending beyond the winding portions 16, such that the adjacent tips 18 are spaced from each other in the circumferential direction to facilitate winding of the winding 20.

Preferably, after spirally winding, stacked layers of the core 10 are fastened together by welding. Referring to FIG. 4, in this embodiment, adjacent layers of core 10 are fastened together by four weld joints A, B, C and D which are respectively located at four ends of an X. Preferably, one weld joint A is located at the outer circumferential surface of the tip 18 of the starting tooth of the strip material and another welding joint D is located at the outer circumferential surface of the tip of the ending tooth of the strip material. The other two welding joints B and C are respectively located at the outer circumferential surfaces of the tips 18 of teeth diametrically opposing the starting and end teeth. Preferably, the starting tooth and the end tooth are spaced with a width of one tooth in the circumferential direction of the core 10.

After the core blank 11 is formed, the windings 20 are wound around the winding portions 16. The tips 18 are pressed to inwardly deform the outward-tilting right half parts of the tips 18 to form the stator structure of FIG. 1. During winding of the winding portions 20, as shown in FIG. 15, because the right half parts of the tips 18 are outwardly tilted relative to the left half parts, the distance between adjacent tips 18 has a sufficient width to facilitate the winding of the windings 20. When pressing the tips 18 to inwardly deform, because the outwardly-tilted right half parts and the winding portions 16 have the notches 37 formed there between, only a smaller external force is required to effect the plastic deformation of bending inward, until the tips closely contact the winding portions 16 to substantially eliminate the previously presented slits 17 such that the right half parts and the left half parts are symmetrical with each other. It should be understood that, after the core blank 11 is formed, the outwardly-tilted parts of the tips 18 can first be forced to bend inward to eliminate the slits 17 to form the core of FIG. 3, and then the windings 20 are wound to form the stator structure of FIG. 1. In comparison, the tips 18 before deformation have a larger distance there between, i.e. the slot opening is larger, which is more advantageous in the winding of the windings 20. Especially for the small sized core 10, the outward-tilting of the tips 18 not only facilitates the winding of the windings 20, but it also ensures the sufficient width of the tips 18 such that the finished core 10 has a narrow slot opening 19. When winding the windings 20 prior to the deformation of the tips 18, the slot opening 19 of the core 10 of the present invention can be sized to form an approximately closed slot, and the width of the slot opening 10 can be less than 0.2 mm. The slits 17 are formed on the same single side of the teeth 14, for example in this embodiment all slits 17 are only formed on the right hand side of the teeth. Therefore, during pressing of the outwardly-tilting part of the tips 38, it is convenient for a pressing machine to inwardly press the tips sequentially in the clockwise direction of the core 10.

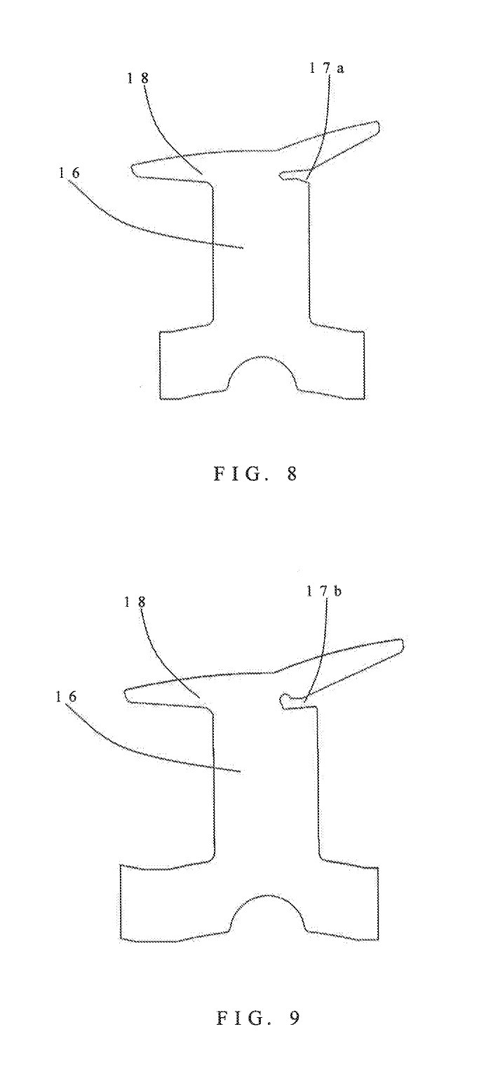

As described above, the core 10 of the stator structure of the present invention is formed by the spiral winding of the strip material 30. The inner space of the yoke 12 is formed by the spiral winding of the yoke blank 32 instead of punching a core material. In comparison with the conventional circular punched sheet structure, the present stator structure can significantly reduce the waste of material, thus increasing the material utilization rate. In addition, the strip material 30 is in the form of an elongated strip. Therefore, multiple strip materials 30 can be arranged parallel to each other in a single piece of material. As shown in FIG. 7, in comparison with the conventional circular punched sheet structure, substantially less material is wasted in between the strip materials 30, which further increases the material utilization rate. Furthermore, the tip 38 is not a symmetrical structure, with its right half part outwardly tilted relative to its left half part. The adjacent tips 38 overlap in the length direction of the strip material. Therefore, the width of the tip 38 is effectively increased. During the spiral winding of the strip material, the teeth 38 extend radially outward to increase the distance between the tips so that the tips 18 no longer overlap in the circumferential direction. The tips 18 can form a narrow slot opening 19 there between, which effectively reduces the cogging torque of the motor. The slit 17 is formed between the tilted tip 18 and the winding portion 16, which provides room for subsequent deformation of the tip 18.

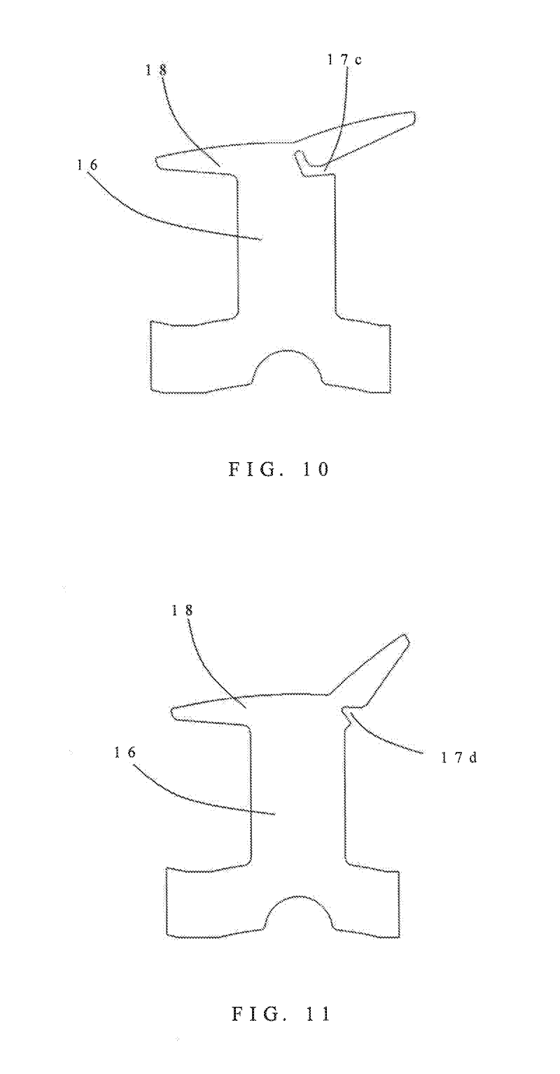

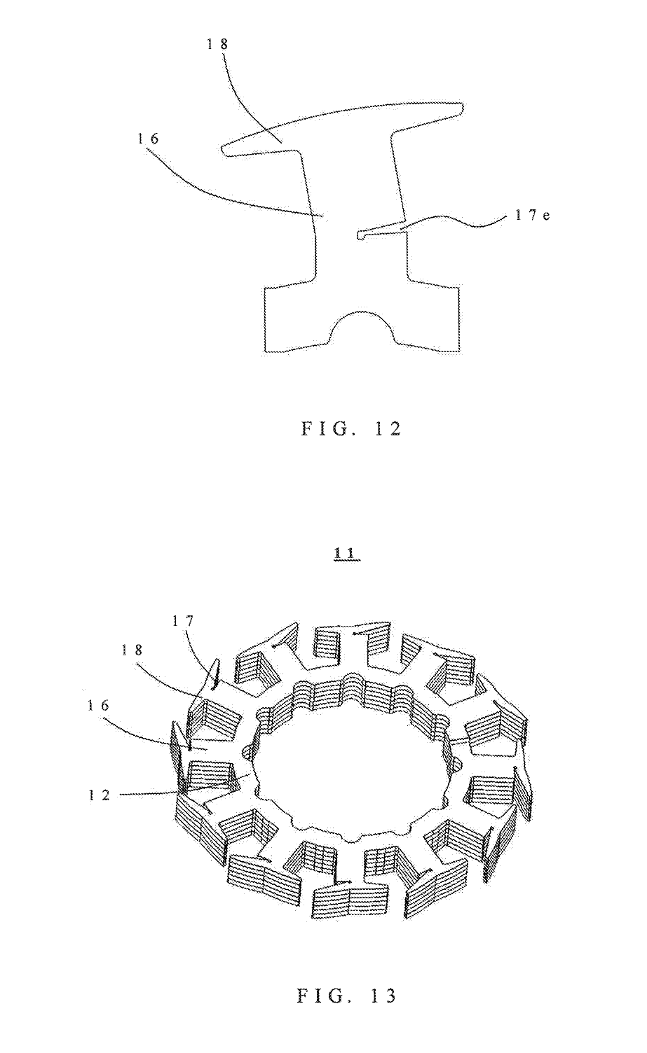

In other embodiments, the slit 17 may have another form and position. As shown in FIG. 8, and FIG. 9, the slit 17a and slit 17b likewise are defined in the area where the tip 18 and the winding portion 16 are connected and extend in the width direction of the winding portion 16, but have different shapes. In addition, as shown in FIG. 10, the slit 17c is defined in the area where the tip 18 and the winding portion 16 are connected and extends in the width direction of the winding portion 16 and then bends to extend outward a distance. The left and right half parts of the tip 18 have a very narrow connecting area there between, which makes the right half part of the tip 18 easier to deform. Further, as shown in FIG. 11 and FIG. 12, the slit 17d and slit 17e are formed in the tip 18 and the winding portion 16, respectively. In FIG. 11, the slit 17d is formed in the part of the tip 18 extending beyond the winding portion 16, which extends a distance into the tip 18 from an inner surface of the tip 18 in the outward direction. In FIG. 12, the slit 17e extends perpendicularly a distance into the winding portion 16 from a middle part of the winding portion 16, and the part of the winding portion 16 outside the slit 17e and the entire tip 18 are tilted relative to the part of the winding portion 16 inside the slit 17e.

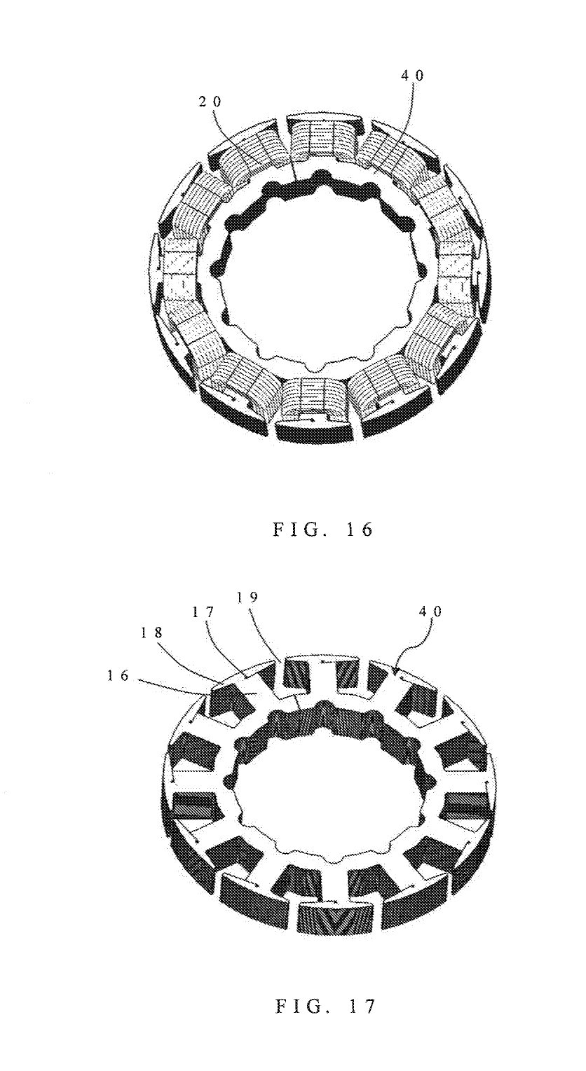

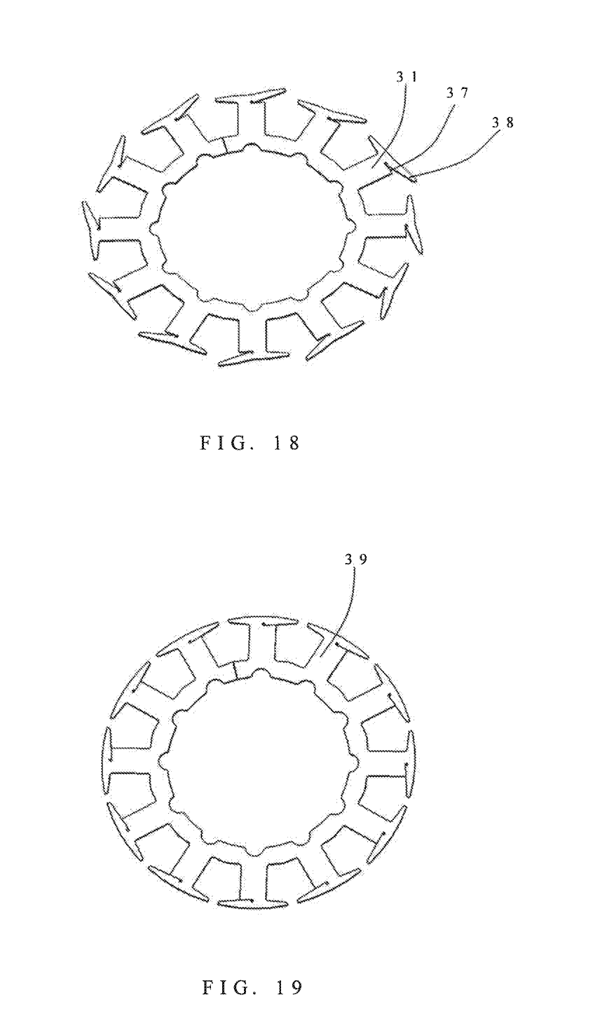

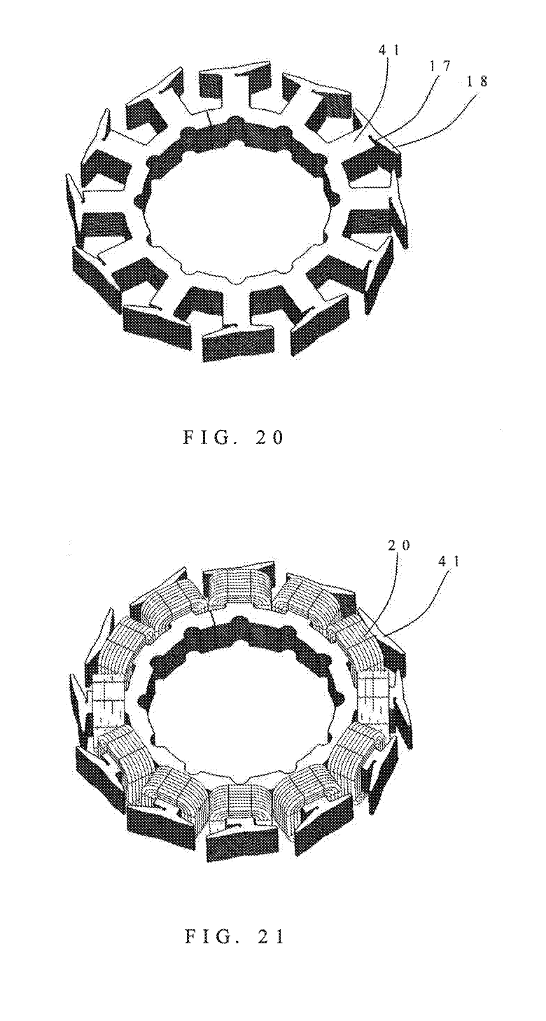

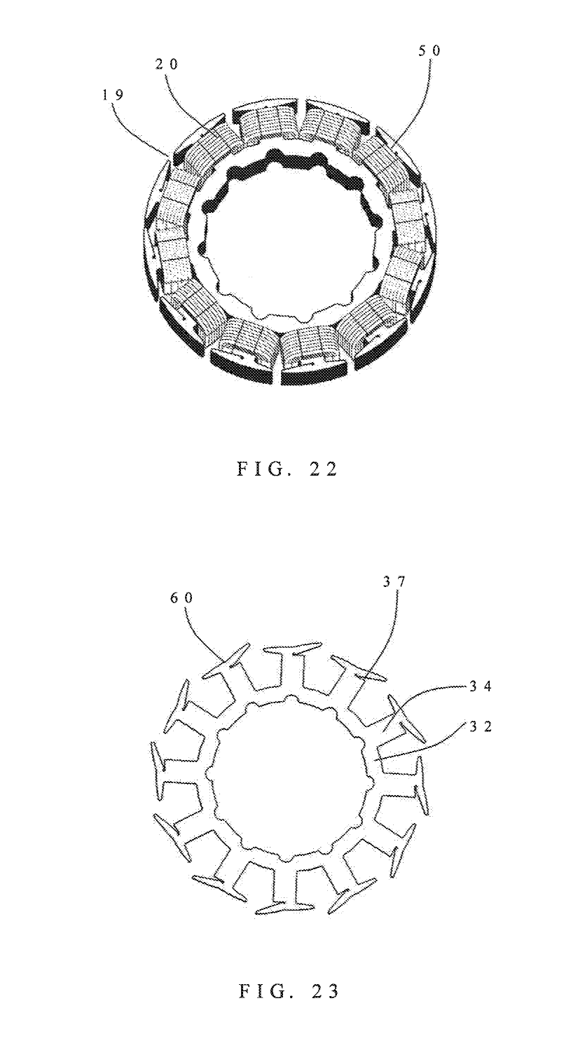

FIG. 16 illustrates a second embodiment of the stator structure of the present invention. The second embodiment is different from the first embodiment in that the core 40 includes a stack of laminations each of which is formed by a strip material 30 that is bent and deformed into a ring. The length of the strip material 30 is approximately the same as the circumference of the yoke 12. The strip material 30 is bent such that opposite ends of the strip material 30 are connected to form a circular ring 31, as shown in FIG. 18. The tips 38 of the circular ring 31 are pressed such that the tilt parts of the tips deform to closely contact the winding portions 36, thus substantially eliminating the notches 37. The lamination 39 as shown in FIG. 19 is thus achieved. Stacking the laminations 39 forms the core 40 of the stator structure of the present embodiment, as shown in FIG. 17. After the stacking process, the laminations 39 may be fastened together by welding. The stator structure as shown in FIG. 16 is formed by winding the windings 20 around the core 40. In addition, it is possible to first stack the circular rings 31 to form the core blank 41 of FIG. 20. After the core blank 41 is formed, the windings 20 may be wound as shown in FIG. 21, and the tips 18 are then pressed to eliminate the slits 17 to form the stator structure of FIG. 16. Alternatively, the tips 18 may be pressed to eliminate the slits 17 to form the core 40 of FIG. 17 and then the windings 20 are wound to form the stator structure of FIG. 16. Therefore, in this embodiment, the stator core 40 may be fabricated in various processes.

Different from the first embodiment, in forming the core 40 of the stator structure of this embodiment, the strip material 30 is bent to form the single circular ring 31, and the circular rings 31 are stacked to form the core 40. In comparison with the process of spirally winding the strip material 30 to form the core 10, one more step is added in this embodiment. However, bending to form the circular lamination is easier to control than spirally winding and, therefore, the production efficiency is not reduced. In addition, bending deformation of the strip material 30 can likewise significantly reduce the waste of material, thereby increasing the material utilization rate. The stator structure thus formed likewise has the narrow slot openings 19, which can effectively reduce the cogging torque.

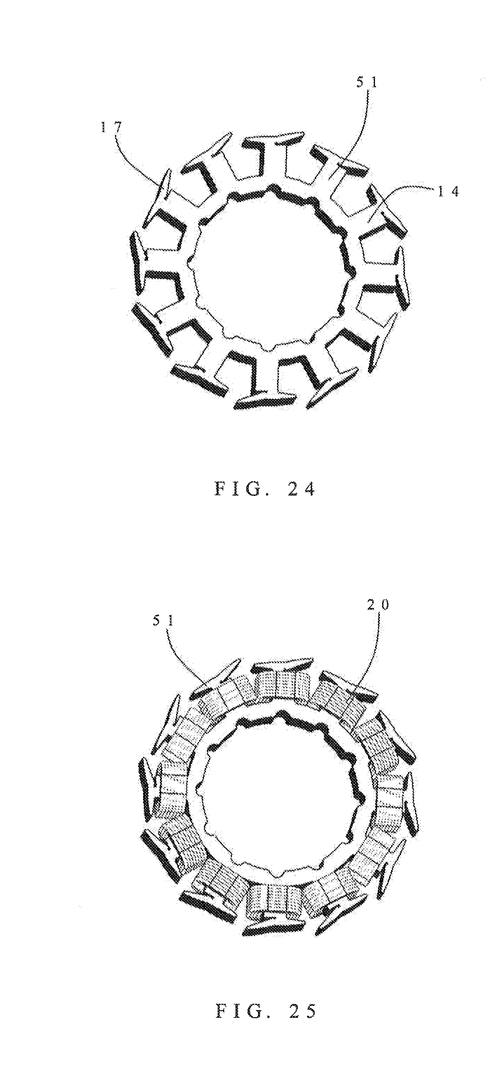

FIG. 22 illustrates a third embodiment of the stator structure of the present invention. In this embodiment, the core 50 includes a stack of punched laminations 60. Referring also to FIG. 23, each punching lamination 60 includes an annular yoke 32 and teeth 34 extending radially outward from the yoke 32. The yoke 32 is of a complete ring. The notch 37 is formed in the area where the linear portion 36 of each tooth 34 and the tip 38 are connected. The right half part of the tip is tilted outward relative to the left half part. In comparison with the conventional silicon steel sheet, the tip 38 has an increased width. Stacking the punched laminations 60 forms the core blank 51 of FIG. 24, with the yokes 32 stacked to form the yoke 12 of the core 50, the teeth 34 stacked to form the teeth 14 of the core 50, and the notches 37 aligned to form the slits 17 in the teeth 14. As shown in FIG. 25, the windings 20 are then wound around the teeth 34 and the tips 18 of the teeth 34 are pressed to deform to eliminate the slits 17, thus forming the stator of this embodiment. Because the tips 38 are tilted outward and hence have the increased width, the slot openings 19 between the tips 18 are narrower, which reduces the cogging torque.

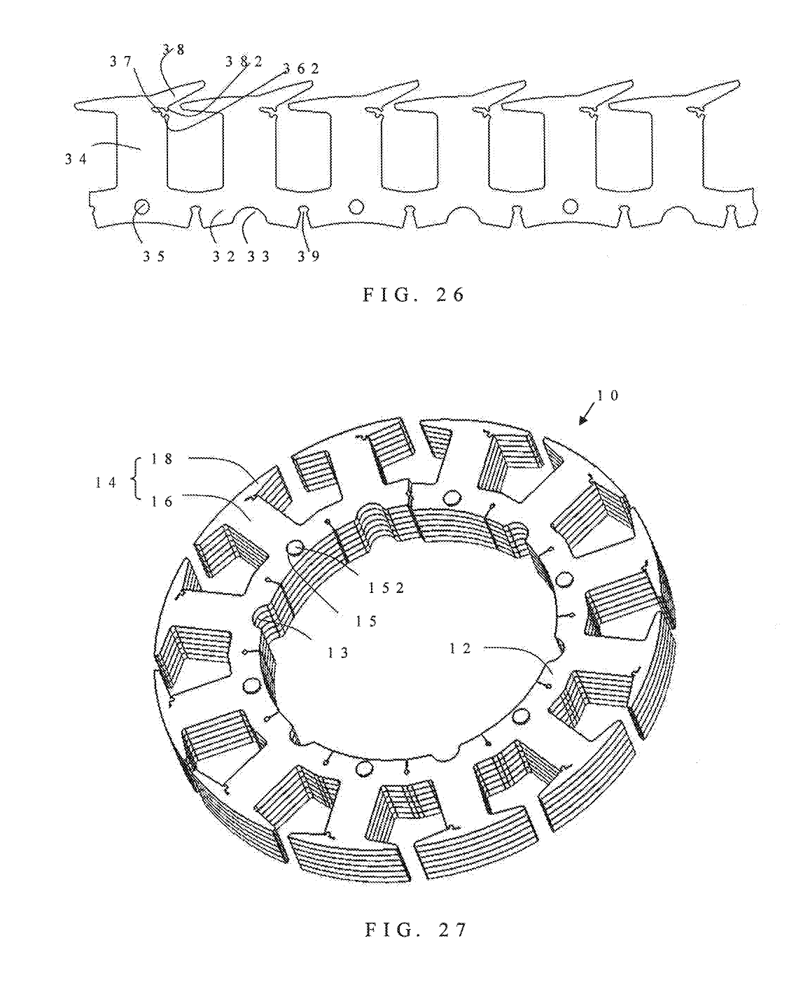

FIG. 26 and FIG. 27 illustrate a stator core according to a fourth embodiment of the present invention. In this embodiment, the stator is formed in the same manner as in the first embodiment, i.e. the core 10 is formed by a strip material 30 spirally wound into a unitary structure, the yoke 12 of the core 10 is a hollow cylindrical structure formed by spirally winding the strip material 30, and the grooves 13 are formed in the inner surface of the yoke 12, which facilitate the bending deformation of the strip material 30 during the spiral winding. The differences include: cutouts 33 and through holes 35 are alternately formed in the yoke blank 32 of the strip material 30, which correspond to the respective tooth blank 34. These cutouts 33 and through holes 35 form the grooves 13 and mounting holes 15, respectively. The mounting hole 15 is spaced a distance from an inner edge of the yoke 12, for allowing a fastener 152 such as a rivet to pass there through to fasten the core 10 together. Preferably, the mounting holes 15 and grooves 13 are spaced apart and evenly distributed in the circumferential direction, with their centers located on central lines of the teeth 14, respectively. The tip 18 and the winding portion 16 further include a latching structure at the slit 17. Specifically, in the tooth blank, the end of the winding portion 16 remote from the yoke blank 32 forms a latching opening 362, and the tip 38 forms a latching protrusion 382 at the notch 37. After the spiral winding is completed, the tip 18 is pressed to make the outwardly tilt right half part of the tip 18 deform inward such that the latching protrusion 382 of the tip 18 is engaged into the latching opening 362 of the winding portion 16. The provision of the latching structure of the tip 38 and winding portion 16 at the slit 17 prevents the tip 18 and the winding portion 16 from disengaging from each other. Notches 39 are formed in the yoke 32 of the strip material 30, corresponding to the respective intervals between the teeth 34, to facilitate the spiral winding of the strip material 30. Understandably, the location of the latching protrusion 382 and latching opening 362 is interchangeable, i.e., the latching protrusion 382 may be formed on the winding portion 16 and the latching opening 363 may be formed in the tip 18.

It should be noted that the core structure of the present invention is not limited to be used as a stator for an outer rotor motor, but it can also be used as a rotor for a brush motor. Thus the stator embodiments are used only as examples of a possible motor armature to which the present invention may be applied.

In the description and claims of the present application, each of the verbs “comprise”, “include”, “contain” and “have”, and variations thereof, are used in an inclusive sense, to specify the presence of the stated item or feature but do not preclude the presence of additional items or features.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of example only, and various other modifications will be apparent to persons skilled in the field without departing from the scope of the invention as defined by the appended claims.

1. A motor armature comprising:
a core, comprising an annular yoke and a plurality of teeth extending radially outwardly from an outer edge of the yoke, each of the teeth comprising a winding portion connected with the yoke and a tip formed at a distal end of the winding portion, each tip having circumferential opposite ends extending beyond the winding portion, a slot opening being formed between ends of adjacent tips; and
windings wound around the winding portions of the teeth of the core and disposed inside the tips,
wherein a slit is formed in each of the teeth on a single circumferential side thereof such that one of said opposite ends of the tip is outwardly tilted relative to the other of said opposite ends in an original position and is bendable inwardly about the slit to a deformed position where a width of the slot opening is less than the width of the slot opening in the original position.

2. The motor armature of claim 1, wherein the slit is formed in an area where the tip and the winding portion are connected.

3. The motor armature of claim 2, wherein the slit extends into the tooth in a circumferential direction of the core and has a depth less than a half of the circumferential width of the winding portion.

4. The motor armature of claim 1, wherein the slit is formed in the part of the tip that extends beyond the winding portion, and the slit extends outwardly a distance into the tip from an inner surface of the tip.

5. The motor armature of claim 1, wherein the slit is formed in the winding portion.

6. The motor armature of claim 1, wherein the slit extends into the tooth from an area where the tip and the winding portion are connected and then bends to extend a distance toward an outer surface of the tip.

7. The motor armature of claim 1, wherein, when the core is unfold in a circumferential direction, a sum of the widths of the parts of the tip extending beyond the winding portion is greater than a distance between adjacent winding portions.

8. The motor armature of claim 1, wherein the core is formed by spirally winding a strip material.

9. The motor armature of claim 1, wherein the core is formed by a stack of laminations, and each lamination is bent, with opposite ends of the lamination connected to each other.

10. The motor armature of claim 1, wherein the core is formed by a stack of punched laminations.

11. The motor armature of claim 1, wherein parts of each of the teeth on opposite sides of the slit form a latching structure.

12. The motor armature of claim 11, wherein the latching structure comprises a latching protrusion formed on one of the tip and winding portion and a latching opening formed in the other of the tip and winding portion.

13. The motor armature of claim 1, wherein the core is fastened together by four weld joints which are located at four ends of an English alphabet X.

14. The motor armature of claim 13, wherein the core is formed by spirally winding a strip material with a starting tooth and an ending tooth, one weld joint is located at an outer circumferential surface of the tip of the starting tooth of the strip material, another weld joint is located at an outer circumferential surface of the tip of the end tooth of the strip material, and the other two weld joints are respectively located at outer circumferential surfaces of the tips of teeth diametrically opposing the starting and end teeth.

15. The motor armature of claim 13, wherein the core is formed by a stack of laminations each of which is bent from a strip material with a starting tooth and an ending tooth, one weld joint is located at an outer circumferential surface of the tip of the starting tooth of the strip material, another weld joint is located at an outer circumferential surface of the tip of the end tooth of the strip material, and the other two weld joints are respectively located at outer circumferential surfaces of the tips of teeth diametrically opposing the starting and end teeth.

16. A method of making a motor armature, the method comprising:
providing a strip material which comprises an elongated yoke blank and a plurality of tooth blanks extending from the yoke blank, each tooth blank comprising a linear portion connected to the yoke blank and a tip formed at a distal end of the linear portion, opposite sides of the tip extending beyond the linear portion, a notch being formed in each tooth blank on a single side thereof such that one of said opposite ends of the tip is outwardly tilted relative to the other of said opposite ends;
forming a core by spirally winding the strip or by stacking laminations formed by bending the strip, whereby the yoke blank forms an annular yoke, the tooth blanks being stacked to form teeth extending outwardly from the yoke, and the notches form slits in the teeth; and
winding windings around the teeth.

17. The method of claim 16, wherein the method further comprises sequentially pressing said one of the opposite ends of the tip outwardly tilted in a clockwise direction or anti-clockwise direction to deform the tilted end of the tip to a deformed position close the slits and narrow a gap between adjacent ends of the tips, after the winding step.

18. The method of claim 16, wherein forming a core further comprises inwardly pressing said one of the opposite ends of the tip outwardly tilted when spirally winding the strip material.
